(19) United States
(12) Patent Application Publication
(10) Pub. No.: US 2019/0270154 A1
(43) Pub. Date: Sep. 5, 2019

(54) TWO-FLUID DEVICE FOR ELECTROEROSION

(71) Applicants: METALSA S.A. DE C.V., Apodaca (MX); LA CORPORACION MEXICANA DE INVESTIGACION EN MATERIALES, S.A. DE C.V., Saltillo (MX); CENTRO DE INGENIERIA Y DESARROLLO INDUSTRIAL, Santiago de Queretaro (MX)

(72) Inventors: Jesus Manuel Orona Hinojos, Saltillo (MX); Melvyn Alvarez Vera, Saltillo (MX); Pedro Perez Villanueva, Saltillo (MX); Rene Javier Hinojosa Garza, Escobedo (MX)

(21) Appl. No.: 15/911,873

(22) Filed: Mar. 5, 2018

(51) Int. Cl. B23H 5/02; B23H 7/26; B23H 7/36

(52) U.S. Cl. CPC B23H 5/02; B23H 7/36; B23H 7/26

(57) ABSTRACT

Electroerosion devices and methods for performing electroerosion machining are disclosed. The electroerosion devices may perform simultaneous electrical discharge machining and pulsed electrochemical machining (S-ED/PEC) through electrode assembly design and the use of two different working fluids.

### BACKGROUND

Electroerosion machining is a machining method that is generally used for machining hard metals or those that would be impossible to machine with other techniques using, e.g., lathes, drills, or the like. Thus, electroerosion machining can be used in trepanning, milling or drilling operations for extremely hard steels and other hard, electrically conductive materials such as titanium, hastelloy, kovar, inconel, carbide, high strength steel or the like. Different types of electroerosion machining include electrical discharge machining (ED) and electrochemical machining (EC).

Both EC and ED processes use electrical current under direct-current (DC) voltage to electrically power removal of the material from the workpiece. In EC, an electrically conductive liquid or electrolyte is circulated between the electrode(s) and the workpiece for permitting electrochemical dissolution of the workpiece material, as well as cooling and flushing the gap region therebetween. In ED, a nonconductive liquid or dielectric (e.g., deionized water having a resistivity of about 2 MΩ·cm to about 10 MΩ·cm) is circulated between the cathode and workpiece to permit electrical discharges in the gap therebetween for removing material from the workpiece.

### SUMMARY

Due to differences of the working fluid needed for EC and ED processes, conventional electroerosion devices are directed to performing one process of either EC or ED, but not both.

In one aspect, disclosed are electroerosion devices comprising an electrode assembly comprising a plurality of tubular electrodes configured to machine a workpiece; a first fluid supply containing a first working fluid having a resistivity from about 0.05 MΩ·cm to about 1.5 MΩ·cm; a second fluid supply containing a second working fluid having a resistivity from about 2 MΩ·cm to about 10 MΩ·cm; a working apparatus operable to rotate the electrode assembly about a central axis thereof and to advance the electrode assembly into the workpiece for machining the workpiece; a power supply electrically coupled to the electrode assembly for powering the electrode assembly; and a control system operable to control the electrical power supplied by the power supply and to control both the rotation and the advance of the electrode assembly by the working apparatus.

In another aspect, disclosed are electroerosion drilling devices comprising a first fluid supply containing a first working fluid having a resistivity from about 0.05 MΩ·cm to about 1.5 MΩ·cm; a second fluid supply containing a second working fluid having a resistivity from about 2 MΩ·cm to about 10 MΩ·cm; an electrode assembly defining a central axis, the electrode assembly comprising a central tubular electrode extending along the central axis and defining a central conduit in fluid communication with the second fluid supply, wherein the central conduit is open toward a distal end of the electrode assembly, a plurality of peripheral tubular electrodes arranged around the central tubular electrode, the plurality of peripheral tubular electrodes defining a plurality of peripheral conduits in fluid communication with the second fluid supply, wherein the plurality of peripheral conduits are open toward the distal end of the electrode assembly, and an outer tubular cover at least partially encircling the central tubular electrode and the plurality of peripheral tubular electrodes, the outer tubular cover defining an interior conduit in fluid communication with the first fluid supply, wherein the interior conduit is open toward the distal end of the electrode assembly; a power supply electrically coupled to the electrode assembly for powering the electrode assembly; a working apparatus operable to rotate the electrode assembly about the central axis and to advance the rotating electrode assembly along the central axis into a workpiece positioned at the distal end of the electrode assembly for drilling the workpiece by electroerosion; and a control system operable to control the electrical power supplied by the power supply and to control both the rotation and the advance of the electrode assembly by the working apparatus.

In another aspect, disclosed are electroerosion milling devices comprising a first fluid supply containing a first working fluid having a resistivity from about 0.05 MΩ·cm to about 1.5 MΩ·cm; a second fluid supply containing a second working fluid having a resistivity from about 2 MΩ·cm to about 10 MΩ·cm; an electrode assembly defining a central axis, the electrode assembly comprising a solid central electrode extending along the central axis, a plurality of peripheral tubular electrodes arranged around the central electrode, the plurality of peripheral tubular electrodes defining a plurality of peripheral conduits in fluid communication with the first fluid supply, wherein the plurality of peripheral conduits are open toward the distal end of the electrode assembly, and an outer tubular cover at least partially encircling the central electrode and the plurality of peripheral tubular electrodes, the outer tubular cover defining an interior conduit in fluid communication with the second fluid supply, wherein the interior conduit is open toward the distal end of the electrode assembly; a power supply electrically coupled to the electrode assembly for powering the electrode assembly; a working apparatus operable to rotate the electrode assembly about the central axis and to advance the rotating electrode assembly along at least one direction that is perpendicular to the central axis while engaged in a workpiece positioned at the distal end of the electrode assembly for milling the workpiece by electroerosion; and a control system operable to control the electrical power supplied by the power supply and to control both the rotation and the advance of the electrode assembly by the working apparatus.

In another aspect, disclosed are electroerosion machining methods, the methods comprising driving an electrode assembly comprising a plurality of tubular electrodes towards a workpiece; supplying or discharging an electrical current between the electrode assembly and the workpiece while feeding a first working fluid from a first fluid supply and a second working fluid from a second fluid supply through a gap defined therebetween; and performing electrical discharge machining (ED), pulsed electrochemical machining (PEC), or a combination thereof, wherein the first working fluid has a resistivity from about 0.05 MΩ·cm to about 1.5 MΩ·cm and the second working fluid has a resistivity from about 2 MΩ·cm to about 10 MΩ·cm.

### BRIEF DESCRIPTION OF THE DRAWINGS

FIG. 1 is a schematic of an electroerosion device, in accordance with one embodiment.

FIG. 2 is an illustration of a side sectional view of an electrode assembly for drilling in accordance with one embodiment.

FIG. 3 is an illustration of a side sectional view of an electrode assembly for drilling in accordance with one embodiment.

FIG. 4 is an illustration of a side sectional view of an electrode assembly for milling in accordance with one embodiment.

FIG. 5 is an illustration of a bottom sectional view of an electrode assembly for milling in accordance with one embodiment.

### DETAILED DESCRIPTION

Disclosed herein are electroerosion devices for metal removal by simultaneous electrical discharge machining and pulsed electrochemical machining—(S-ED/PEC). The disclosed electroerosion devices can change from electrical discharge machining (ED) and pulsed electrochemical machining (PEC) modes (and vice versa) through the use of a combination of two working fluids and advantageous electrode assembly design. The disclosed electroerosion devices, taking advantage of both ED and PEC processes, are able to provide improved precision, while lowering the overall cost of providing machined workpieces. In addition, the working fluids disclosed herein are renewable resources, thereby decreasing the environmental impact of using the electroerosion devices.

The disclosed electroerosion devices combine electro-thermal discharge with electro-ionic dissolution that can provide S-ED/PEC machining conditions. The pulsed signal can be divided in two on-time conditions for each ED and PEC process. The pulsed signal can be considered to increase the material removal rate (MRR), which is an important factor for ED processes. One of the characteristics of the disclosed ED/PEC hybrid devices is an increase in material removal efficiency, as indicated by a higher MRR, and a reduction in surface roughness. However, it is known that ED processes that can significantly improve MRR also typically result in providing a heat affect zone (HAZ), which can be detrimental to workpieces. In contrast to these known ED processes, the disclosed ED/PEC processes have been found to significantly increase MRR, while also reducing the HAZ by approximately 10 times at about 2 to 20 μm.

### 1. Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, are expressly enumerated in this specification. These are only examples of what is specifically intended, and all possible combinations of numerical values between and including the lowest value and the highest value enumerated are to be considered to be expressly stated in this application.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

### 2. Electroerosion Device

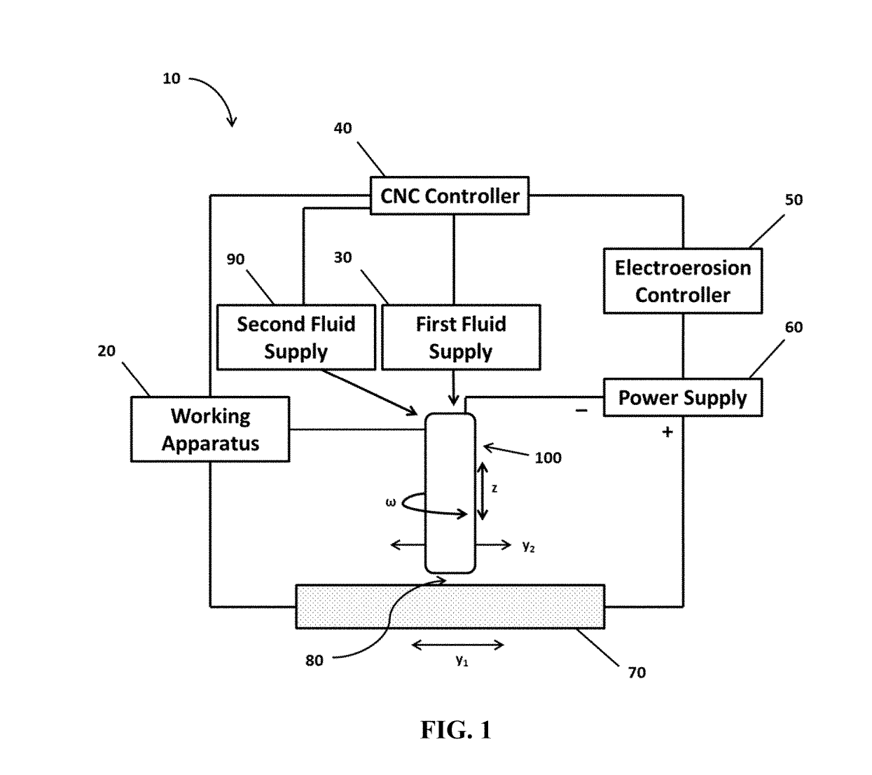

FIG. 1 schematically illustrates an electroerosion device, such as a device 10 for performing ED, PEC, or both, in accordance with some embodiments of the invention. In an embodiment of the invention, the electroerosion device 10 is used to remove material from a workpiece 70 layer by layer to form a desired configuration. The electroerosion device 10 may comprise a working apparatus 20, a numerical controller (NC) 40, a power supply 60, a first fluid supply 30, a second fluid supply 90, an electroerosion controller 50, and an electrode assembly 100.

A. Electrode Assembly

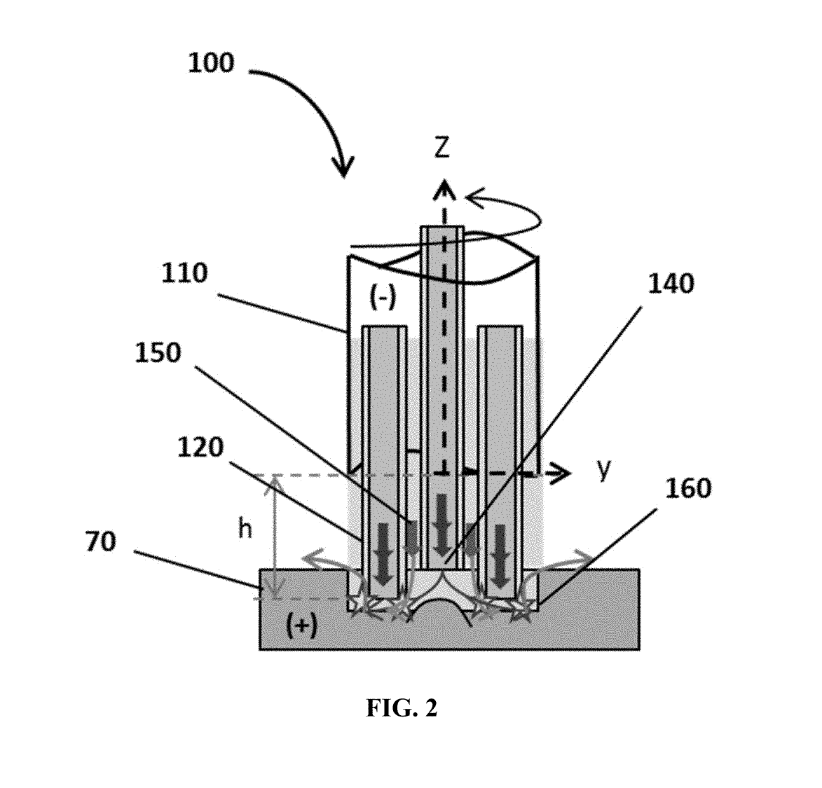

The electrode assembly 100 can be configured to machine any desired configuration in the workpiece 70. FIGS. 2-4 illustrate exemplary electrode assemblies 100 of the electroerosion device 10. The electrode assembly 100 may be mounted to the working apparatus 20 through any suitable means known within the art. The electrode assembly 100 may include an outer tubular cover 110 and a plurality of tubular electrodes 120 (e.g., from 4 to 36 metal poles) positioned within the tubular cover 110. The tubular cover 110 may have a diameter of about 6.5 mm to about 70 mm. The plurality of tubular electrodes 120 define a plurality of conduits that are open toward the distal end of the electrode assembly 100. The plurality of tubular electrodes 120 are configured to allow working fluid(s) to be fed through a hollow channel (within the individual electrode(s)) and towards the workpiece 70. In addition, the plurality of tubular electrodes 120 may be arranged in any suitable geometric pattern. In some embodiments, the plurality of tubular electrodes 120 comprises 4 to 36 individual electrodes arranged in a circular pattern.

The plurality of tubular electrodes 120 may be centered around a central electrode 180 that is either solid or tubular. The central electrode 180 may extend along the central axis of the electrode assembly 100. In such embodiments, the plurality of tubular electrodes 120 may be referred to as a plurality of peripheral tubular electrodes. In embodiments that the central electrode 180 is tubular it is configured to allow working fluid(s) to be fed through a hollow channel (within the individual electrode) and towards the workpiece 70. The plurality of tubular electrodes 120, the central electrode 180, or both may protrude from the outer tubular cover 110. For instance, the plurality of tubular electrodes 120, central electrode 180, or both may protrude from the outer tubular cover 110 by about 1 mm to about 5 mm.

The plurality of tubular electrodes 120 and the central electrode 180, at each occurrence, may independently comprise a conductive material, such as bronze, copper, silver, aluminum, steel or any metallic alloy suitable for performing the function of the disclosed electroerosion device 10. In some embodiments, the plurality of tubular electrodes 120 and the central electrode 180 are each individually bronze. The plurality of tubular electrodes 120 and the central electrode 180, at each occurrence, independently may have a diameter from about 0.5 mm to about 6.5 mm.

The electrode assembly 100 may be in fluid communication with the first fluid supply 30 and the second fluid supply 90. A first working fluid 150 and a second working fluid 140 (described in greater detail below) can be fed through the electrode assembly 100 and dispensed onto the workpiece 70 to aid in electroerosion processes and removal of material. The electrode assembly 100 is configured to dispense the first working fluid 150 and the second working fluid 140 through distinct pathways/conduits through the electrode assembly 100 towards the workpiece 70. In some embodiments, the plurality of tubular electrodes 120 include a set of electrodes, each individually having a conduit configured to dispense either the first working fluid 150 or the second working fluid 140 through said conduit.

The above description of the plurality of tubular electrodes 120, the central electrode 180 and the outer tubular cover 110 may be applied (when appropriate) to the different drilling and milling embodiments as described below.

i. Drilling

FIG. 2 illustrates an exemplary electrode assembly 100 of the electroerosion device 10 in ED drilling mode, where the first working fluid 150, such as a low-resistivity-dielectric fluid that may include electrolytes, is fed through the space between the outer tubular cover 110 and the plurality of tubular electrodes 120 and the central tubular electrode 180 (and the space between the electrodes), and the second working fluid 140, such as a dielectric fluid, is fed through the conduits of the electrodes to the cutting front 160 of the workpiece, thereby allowing ED processes to occur.

The plurality of tubular electrodes 120 may be a plurality of peripheral tubular electrodes 120 centered around a central tubular electrode 180. The plurality of peripheral tubular electrodes 120 may define a plurality of peripheral conduits in fluid communication with the second fluid supply 90. The central tubular electrode 180 may define a central conduit in fluid communication with the second fluid supply 90. In addition, the outer tubular cover 110 (at least partially encircling the electrodes) may define an interior conduit in fluid communication with the first fluid supply 30. In some drilling embodiments, the plurality of tubular electrodes 120 are closer in proximity to the workpiece 70 compared to the central tubular electrode 180. In some drilling embodiments, the outer tubular cover 110 has a diameter of about 6.5 mm to about 30 mm.

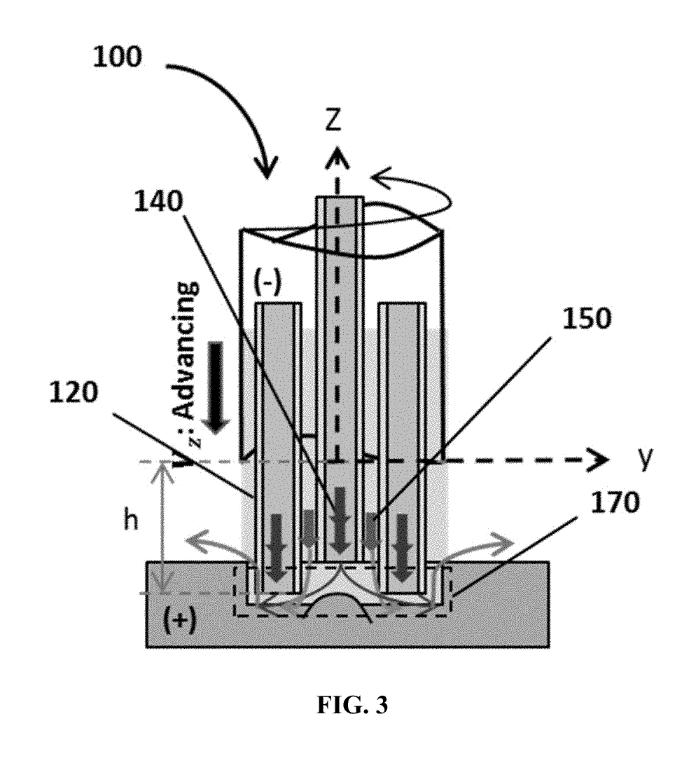

FIG. 3 illustrates an exemplary electrode assembly 100 of the electroerosion device 10 in PEC drilling mode. The electrode assembly 100 comprising a plurality of tubular electrodes 120 advances in the direction towards the workpiece 70 (e.g., in the z-direction) with the first working fluid 150 and the second working fluid 140 being fed through the electrode assembly 100 and dispensed onto the workpiece 70 as described above in FIG. 2. The plurality of tubular electrodes 120 is arranged within the outer tubular cover 110 with the central tubular electrode 180. FIG. 3 depicts the electrode assembly 100 overcutting 170 the workpiece 70 by ionic dissolution PEC.

FIG. 2 and FIG. 3 depict embodiments that can allow material to be locally removed by transversal wall-ring tooling on the workpiece 70 during the drilling movement. The plurality of tubular electrodes 120 and the central tubular electrode 180 being the cathode needed to work with pulsed power supply 60 on the workpiece 70, the anode in this instance. In some embodiments, the plurality of tubular electrodes 120 and the central tubular electrode 180 are connected in a parallel circuit, allowing for both ED and PEC processes to be performed.

ii. Milling

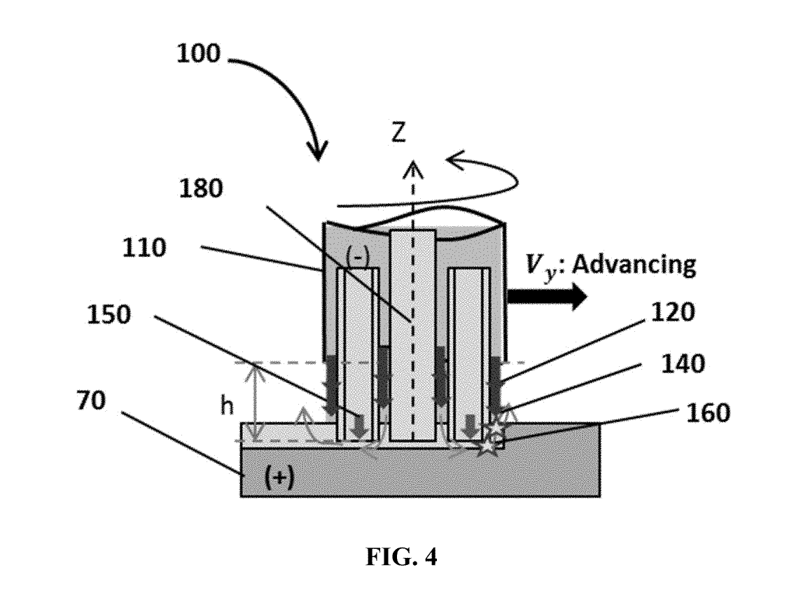

FIG. 4 illustrates another embodiment of the electrode assembly 100 of the electroerosion device 10 in S-ED/PEC milling modes. The electrode assembly 100 advances along the workpiece 70 (e.g., in the y-direction). The plurality of tubular electrodes 120 is arranged within the outer tubular cover 110 with a central solid electrode 180. The central solid electrode 180 may be the same distance from the workpiece 70 relative to the plurality of tubular electrodes 120. FIG. 4 depicts the first working fluid 150 being fed through the conduits of the electrodes, and the second working fluid 140 being fed through the space between the outer tubular cover 110 and the plurality of tubular electrodes 120 and the central solid electrode 180 (and the space between the electrodes).

The plurality of tubular electrodes 120 may be a plurality of peripheral tubular electrodes 120 centered around a central solid electrode 180. The plurality of peripheral tubular electrodes 120 may define a plurality of peripheral conduits in fluid communication with the first fluid supply 30. In addition, the outer tubular cover 110 (at least partially encircling the electrodes) may define an interior conduit in fluid communication with the second fluid supply 90. In some milling embodiments, the outer tubular cover 110 has a diameter of about 30 mm to about 70 mm.

The cutting front 160 for ED processes and workpiece 70 are also depicted in FIG. 4. Milling embodiments can allow for local removal of material (e.g., of the workpiece) by parallel wall tooling, layer by layer.

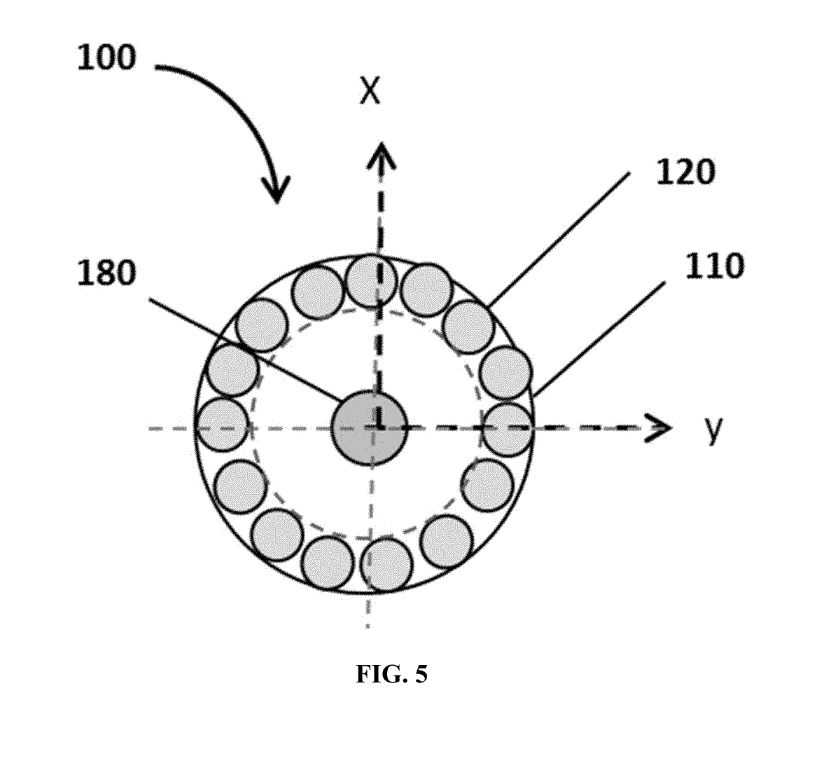

FIG. 5 illustrates a bottom cross-sectional view of an arrangement of the plurality of tubular electrodes 120 positioned around the central solid electrode 180 within the outer tubular cover 110 of the electrode assembly 100.

B. Fluid Supply

The electroerosion device 10 uses a first fluid supply 30 to provide a first working fluid 150 and a second fluid supply 90 to provide a second working fluid 140 to perform PEC, ED, or both. For example, the first fluid supply 30 contains the first working fluid 150 and is configured to feed the first working fluid 150 between the electrode assembly 100 and the workpiece 70. In addition, the second fluid supply 90 contains a second working fluid 140 and is configured to feed the second working fluid 140 between the electrode assembly 100 and the workpiece 70. The first working fluid 150 is a quasi-dielectric fluid, such as low-resistivity deionized water, and can be used for PEC processes. The quasi-dielectric fluid may include deionized water. In addition, the quasi-dielectric fluid may include a dissolved solid, such as a salt. Examples of salts include, but are not limited to, NaCl, KCl, NaBr, Na₂SO₄, NaNO₃ and combinations thereof. Low-resistivity, as used herein, refers to a fluid having a resistivity from about 0.05 MΩ·cm to about 1.5 MΩ·cm. In an exemplary embodiment, the first working fluid 150 has a resistivity of about 0.1 MΩ·cm to about 0.75 MΩ·cm. The resistivity of the quasi-dielectric fluid can be adjusted by varying small concentrations of total dissolved solids (TDS) within the fluid. For example, TDS can be added to the quasi-dielectric fluid at a few parts per million. The second working fluid 140 is a dielectric fluid, such as deionized water, and can be used for ED processes. The second working fluid 140 may have a resistivity from about 2 MΩ·cm to about 10 MΩ·cm.

In some embodiments, the first and the second working fluids are fed into the inside of the electrode assembly 100 at high pressure by a pump system, and are ejected through the electrode assembly 100 to the workpiece 70, while the electrode assembly is rotating.

In some embodiments, the first fluid supply 30 and the second fluid supply 90 may be in communication with and receive pre-programmed instructions from the NC 40 for feeding the first and second working fluids between the electrode assembly 100 and the workpiece 70. Alternatively, the first fluid supply 30 and second fluid supply 90 may be disposed separately. During electroerosion machining (either PEC, ED or a combination thereof), the power supply 60 may supply or discharge a pulse electric current between the electrode assembly 100 and the workpiece 70 to remove material from the workpiece 70 layer by layer for forming a desired configuration while the working fluid(s) carry the removed material out of the gap 80.

C. Working Apparatus

The electroerosion device 10 includes a working apparatus 20 that is configured to move the electrode assembly 100 relative to the workpiece 70, and which in turn is controlled by a control system. The working apparatus 20 may be operable to rotate the electrode assembly 100 about a central axis thereof to advance the electrode assembly 100 toward and into the workpiece 70 (e.g., drilling). In addition, the working apparatus 20 may be operable to rotate the electrode assembly 100 about a central axis thereof to advance the electrode assembly 100 in a direction perpendicular to the central axis while engaged with the workpiece 70 (e.g., milling).

In some embodiments, the NC 40 device can be used to perform conventional automated machining. In some examples, the working apparatus 20 may comprise a machine tool or lathe including servomotors (not shown) and spindle motors (not shown), which are known to one skilled in the art. The electrode assembly 100 may be mounted on the working apparatus 20 for performing electroerosion machining. The servomotors may drive the electrode assembly 100 and the workpiece 70 to move opposite to each other at a desired speed and path, and the spindle motors may drive the electrode assembly 100 to rotate at a desired speed. The electroerosion device 10 may perform both milling and drilling processes via electroerosion techniques.

D. Power Supply

The power supply 60 electrically powers the electrode assembly 100. In the illustrated embodiment of FIG. 1, the power supply 60 may comprise a direct current (DC) pulse generator. The electrode assembly 100 and the workpiece 70 can be connected to negative and positive poles of the power supply 60, respectively. Accordingly, in some embodiments, the electrode assembly 100 may function as a cathode and the workpiece 70 may act as an anode. In other embodiments, the polarities on the electrode assembly 100 and the workpiece 70 may be reversed. The power supply 60 may function at a range of about 1 kHz to about 25 kHz. In addition, the power supply may have an open circuit voltage of about 50 VDC to about 80 VDC and about 200 amperes to about 800 amperes.

E. Numerical Controller (NC)

The electroerosion device 10 includes a control system, e.g., the NC 40, for allowing communication between different elements of the electroerosion device 10. The control system 40 may be configured to control the electrical power supplied by the power supply 60, as well as both the rotation and the advance of the electrode assembly 100.

In some embodiments, the NC 40 is a computer numerical controller (CNC). The CNC 40 comprises pre-programmed instructions based on descriptions of the workpiece 70 in a computer-aided design (CAD) and a computer-aided manufacturing (CAM), and may be connected to the working apparatus 20 to control the working apparatus 20 to drive the electrode assembly 100 to move, rotate or both according to certain operational parameters, such as certain feed rates, axes positions, or spindle speeds. In some embodiments, the CNC 40 is a general CNC and comprises central processing units (CPU), read only memories (ROM), random access memories (RAM), or both as known to one skilled in the art.

The CNC 40 may provide multi-axes movements of the electrode assembly 100 (e.g., x, y₂ and z directions, as well as rotation (w)) and workpiece 70 (e.g., y₁ direction) for 3D complex machining. For example, the CNC 40 determines a machining path for the positioning of the electrode assembly 100 on the workpiece 70. The electrode assembly 100 may comprise electromechanical components that are in communication with the CNC 40. The position(s) of the electrode assembly 100 may be controlled by an algorithm that defines the gap distance 80 (from nm to μm) on axis “z”, which can be critical for the removal of material in a controlled manner via PEC, ED, or both. In addition, the algorithm may control the movement of the electrode assembly 100 along the surface contour of the workpiece 70 with movements on axes “x, y” according to a machining sequence. The algorithm can control the adjustment of penetration position of the “z”-axis to maintain the S-PEC/ED processes. The electroerosion device 10 may be operated by the algorithm having pulsed electrical signals in voltage and current relationship that are fed into the algorithm, such as fuzzy logical, neural network or heuristic rules. The control algorithm may allow self-adjustment of the gap distance 80 in “z”-axis between the electrode assembly 100 and workpiece 70, as well as electrical parameters of the discharge condition and electro-dissolution conditions for improved removal of material.

F. Electroerosion Controller

The electroerosion device 10 may include an electroerosion controller 50 connected to the power supply 60 to monitor the status of the power supply 60. In some embodiments, the electroerosion controller 50 comprises one or more sensors (not shown), such as a voltage and/or current measurement circuit for monitoring the status of voltages and/or currents in the gap 80 between the electrode assembly 100 and the workpiece 70. In other embodiments, the sensor(s) is comprised in the power supply 60. In yet other embodiments, the sensor(s) is not comprised in the electrode assembly 100 or power supply 60, but rather are separate individual units relative to the electrode assembly 100 and power supply 60. In some embodiments, the electroerosion controller 50 comprises a microprocessor or another computational device, a timing device, a voltage comparison device, and/or a data storage device to be served as the sensor(s), as known to one skilled in the art. Additionally, the electroerosion controller 50 may communicate with the NC 40 to control the power supply 60 and the movement of the working apparatus 20 holding the electrode assembly 100.

### 3. Methods of Using the Electroerosion Devices

Also disclosed herein are methods of performing electroerosion machining methods using the electroerosion device 10 as described above. In particular, the electroerosion device 10 may be used for drilling, milling or both modes. In both drilling and milling modes, the first working fluid 150 has a resistivity from about 0.05 MΩ·cm to about 1.5 MΩ·cm, and the second working fluid 140 has a resistivity from about 2 MΩ·cm to about 10 MΩ·cm. Accordingly (and as described above), the first working fluid 150 may be used for PEC processes and the second working fluid 150 may be used for ED processes.

The flow rates of the first working fluid 150 and the second working fluid 140 are influenced by the pressures needed to machine the workpiece 70. The first working fluid 150 may be fed between the electrode assembly 100 and the workpiece 70 at a flow rate of about 6 MPa to about 8.5 MPa. In addition, the first working fluid 150 can have a gradient ion concentration. The second working fluid 140 may be fed between the electrode assembly 100 and the workpiece 70 at a flow rate of about 6 MPa to about 8.5 MPa.

The electroerosion device 10 can switch from drilling to milling modes by changing the electrode assembly 100 and locking the electrode assembly 100 either in the vertical position (e.g., drilling mode) or the horizontal position (e.g., milling mode).

A. Drilling

In drilling mode, the electroerosion device 10 can use an electrode assembly 100 as depicted in FIG. 2. The electrode assembly 100 can advance along the central axis of the electrode assembly 100 into the workpiece 70. In drilling mode, the second working fluid 140 is fed through the conduits of the electrodes 120 to the cutting front 160 of the workpiece 70 to perform ED processes. The first working fluid 150 is fed through the space between the outer tubular cover 110 and the plurality of tubular electrodes 120 and the central tubular electrode 180 (and the space between the electrodes) and can smooth the surface of the machined workpiece 70 via. PEC processes. In addition, during drilling the peripheral electrodes 120 may remove material at a different rate than the central tubular electrode 180, potentially creating a raised surface in the middle of the cutting zone 170. Accordingly, the electrode assembly 100 may have a tubular central electrode 180 that can dispense the second working fluid 140 toward the workpiece 70 and the plurality of peripheral tubular electrodes 120 may extend further toward the distal end of the electrode assembly 100 than the central tubular electrode 180 (e.g., the peripheral tubular electrodes 120 are of set relative to the tubular central electrode 180). This configuration of the electrode assembly 100 for drilling can allow for a final smooth and even surface machined into the workpiece 70.

B. Milling

In milling mode, the electroerosion device 10 can use an electrode assembly 100 as depicted in FIG. 4. The electrode assembly 100 can advance along the workpiece 70 in a direction that is perpendicular to the central axis of the electrode assembly 100. In milling mode, the second working fluid 140 is fed through the space between the outer tubular cover 110 and the plurality of tubular electrodes 120 and the central solid electrode 180 (and the space between the electrodes) at the leading front to perform ED processes. The first working fluid 150 is fed through the conduits of the electrodes 120 and can smooth the surface of the machined workpiece 70 via PEC processes. In addition, the central electrode 180 can be solid and can extend to a common axial position as the plurality of tubular electrodes 120 because the electrode assembly 100 does not create a significantly raised surface on the workpiece 70 during milling mode (which can be seen in drilling mode as described above).

What is claimed is:

1. An electroerosion device comprising:
an electrode assembly comprising a plurality of tubular electrodes configured to machine a workpiece;
a first fluid supply containing a first working fluid having a resistivity from about 0.05 MΩ·cm to about 1.5 MΩ·cm;
a second fluid supply containing a second working fluid having a resistivity from about 2 MΩ·cm to about 10 MΩ·cm;
a working apparatus operable to rotate the electrode assembly about a central axis thereof and to advance the electrode assembly into the workpiece for machining the workpiece;
a power supply electrically coupled to the electrode assembly for powering the electrode assembly; and
a control system operable to control the electrical power supplied by the power supply and to control both the rotation and the advance of the electrode assembly by the working apparatus.

2. The electroerosion device of claim 1, wherein the electrode assembly further comprises an outer tubular cover, and wherein the plurality of tubular electrodes are positioned radially within the outer tubular cover.

3. The electroerosion device of claim 2, wherein the plurality of tubular electrodes extend further toward the distal end of the electrode assembly than the outer tubular cover.

4. The electroerosion device of claim 1, wherein the electrode assembly is configured to dispense the first working fluid and the second working fluid through different conduits within the electrode assembly.

5. The electroerosion device of claim 1, wherein the plurality of tubular electrodes are each individually configured to dispense the first working fluid, the second working fluid, or both.

6. The electroerosion device of claim 1, wherein the plurality of tubular electrodes, at each occurrence, independently comprise aluminum, silver, brass, bronze, copper, steel or a combination thereof.

7. The electroerosion device of claim 1, wherein the plurality of tubular electrodes comprises 4 to 30 individual electrodes arranged in a circular pattern.

8. The electroerosion device of claim 1, wherein the plurality of tubular electrodes are centered around a central electrode, the central electrode extending along the central axis of the electrode assembly.

9. The electroerosion device of claim 1, wherein the first working fluid comprises NaCl, KCl, NaBr, Na₂SO₄, NaNO₃ or a combination thereof.

10. The electroerosion device of claim 1, wherein the second working fluid is deionized water.

11. The electroerosion device of claim 1, wherein the power supply causes the plurality of tubular electrodes to have a positive polarity and the workpiece to have a negative polarity.

12. An electroerosion machining method, the method comprising:
driving an electrode assembly comprising a plurality of tubular electrodes towards a workpiece;
supplying an electrical current between the electrode assembly and the workpiece while feeding a first working fluid from a first fluid supply and a second working fluid from a second fluid supply through a gap defined therebetween; and
performing electrical discharge machining (ED), pulsed electrochemical machining (PEC), or a combination thereof,
wherein the first working fluid has a resistivity from about 0.05 MΩ·cm to about 1.5 MΩ·cm and the second working fluid has a resistivity from about 2 MΩ·cm to about 10 MΩ·cm.

13. The method of claim 12, wherein the electrode assembly further comprises an outer tubular cover and the plurality of tubular electrodes are positioned within the outer tubular cover.

14. The method of claim 12, wherein the electrode assembly is configured to dispense the first working fluid and the second working fluid through different conduits within the electrode assembly.

15. An electroerosion drilling device comprising:
a first fluid supply containing a first working fluid having a resistivity from about 0.05 MΩ·cm to about 1.5 MΩ·cm;
a second fluid supply containing a second working fluid having a resistivity from about 2 MΩ·cm to about 10 MΩ·cm;
an electrode assembly defining a central axis, the electrode assembly comprising
a central tubular electrode extending along the central axis and defining a central conduit in fluid communication with the second fluid supply, wherein the central conduit is open toward a distal end of the electrode assembly,
a plurality of peripheral tubular electrodes arranged around the central tubular electrode, the plurality of peripheral tubular electrodes defining a plurality of peripheral conduits in fluid communication with the second fluid supply, wherein the plurality of peripheral conduits are open toward the distal end of the electrode assembly, and
an outer tubular cover at least partially encircling the central tubular electrode and the plurality of peripheral tubular electrodes, the outer tubular cover defining an interior conduit in fluid communication with the first fluid supply, wherein the interior conduit is open toward the distal end of the electrode assembly;
a power supply electrically coupled to the electrode assembly for powering the electrode assembly;
a working apparatus operable to rotate the electrode assembly about the central axis and to advance the rotating electrode assembly along the central axis into a workpiece positioned at the distal end of the electrode assembly for drilling the workpiece by electroerosion; and
a control system operable to control the electrical power supplied by the power supply and to control both the rotation and the advance of the electrode assembly by the working apparatus.

16. The electroerosion drilling device of claim 15, wherein the central tubular electrode extends further toward the distal end of the electrode assembly than the outer tubular cover.

17. The electroerosion drilling device of claim 15, wherein the plurality of peripheral tubular electrodes extends further toward the distal end of the electrode assembly than the central tubular electrode.

18. An electroerosion milling device comprising:
a first fluid supply containing a first working fluid having a resistivity from about 0.05 MΩ·cm to about 1.5 MΩ·cm;
a second fluid supply containing a second working fluid having a resistivity from about 2 MΩ·cm to about 10 MΩ·cm;
an electrode assembly defining a central axis, the electrode assembly comprising
a solid central electrode extending along the central axis,
a plurality of peripheral tubular electrodes arranged around the central electrode, the plurality of peripheral tubular electrodes defining a plurality of peripheral conduits in fluid communication with the first fluid supply, wherein the plurality of peripheral conduits are open toward the distal end of the electrode assembly, and
an outer tubular cover at least partially encircling the central electrode and the plurality of peripheral tubular electrodes, the outer tubular cover defining an interior conduit in fluid communication with the second fluid supply, wherein the interior conduit is open toward the distal end of the electrode assembly;
a power supply electrically coupled to the electrode assembly for powering the electrode assembly;
a working apparatus operable to rotate the electrode assembly about the central axis and to advance the rotating electrode assembly along at least one direction that is perpendicular to the central axis while engaged in a workpiece positioned at the distal end of the electrode assembly for milling the workpiece by electroerosion; and
a control system operable to control the electrical power supplied by the power supply and to control both the rotation and the advance of the electrode assembly by the working apparatus.

19. The electroerosion milling device of claim 18, wherein the solid central electrode and the plurality of peripheral tubular electrodes extend further toward the distal end of the electrode assembly than the outer tubular cover.

20. The electroerosion milling device of claim 18, wherein the solid central electrode and the plurality of peripheral tubular electrodes extend to a common axial position defining the distal end of the electrode assembly.
